(19) United States
(12) Patent Application Publication
(10) Pub. No.: US 2002/0099702 A1
(43) Pub. Date: Jul. 25, 2002

(54) Method and apparatus for data clustering

(76) Inventor: Anthony Scott Oddo, Jamaica Plain, MA (US)

Correspondence Address: HALE AND DORR, LLP, 60 STATE STREET, BOSTON, MA, 02109

(21) Appl. No.: 09/766,377

(22) Filed: Jan. 19, 2001

(51) Int. Cl. G06F 7/00

(52) U.S. Cl. 707/6

(57) ABSTRACT

A method and apparatus are provided for clustering data inputs into groups. The first data input is initially designated as center of a first group. Each other data input is successively analyzed to identify a group whose center is sufficiently close to that data input. If such a group is identified, the input is assigned to the identified group. If no such group is identified, a new group is created and the data input is designated as the center of the new group. The analysis of data inputs is repeated until all data inputs have been assigned to groups. Optionally, thereafter for optimal performance, for each data input, the closest group center to that input is determined, and the data input is assigned to the group having that center.

### BACKGROUND OF THE INVENTION

1. Field of the Invention

The present invention relates generally to analysis of data and, more particularly, to a method and apparatus for data clustering.

2. Description of Related Art

Data mining is used to query large databases (with potentially millions of entries) and receive responses in real time. It typically involves sorting through a large collection of data that may have no predetermined similarities (other than, e.g., that they are all data of the same size and general type) and organizing them in a useful way. A common method of organizing data uses a clustering algorithm to group data into clusters based on some measure of the distance between them. One of the most popular clustering algorithms is the K-means clustering algorithm.

Briefly, the K-means algorithm clusters data inputs (i.e., data entries) into a predetermined number of groups (e.g., ‘K’ groups). Initially, the inputs are randomly partitioned into K groups or subsets. A mean is then computed for each subset. The degree of error in the partitioning is determined by taking the sum of the Euclidean distances between each input and the mean of a subset over all inputs and over all subsets. On each successive pass through the inputs, the distance between each input and the mean of each group is calculated. The input vector is then assigned to the subset to which it is closest. The means of the K subsets are then recalculated and the error measure is updated. This process is repeated until the error term becomes stable.

One advantage of the K-means method is that the number of groups is predetermined and the dissimilarity between the groups is minimized. The K-means method is, however, computationally very expensive, with a time complexity of O(R K N) where K is the number of desired clusters, R is the number of iterations, and N is the number of data inputs. Time complexity is a measure of the computation time needed to generate a solution to a given instance of a problem. Problems with a time complexity if O(N) are generally solvable in real time, whereas problems with a time complexity of O(N^{k}) are not known to be solvable in real time.

An alternative approach uses neural networks to classify the inputs. For example, Adaptive Resonance Theory (ART) is a set of neural networks algorithms that have been developed to classify patterns. Some versions of ART use supervised learning (e.g., ARTMAP and Fuzzy ARTMAP) Other versions use unsupervised learning (e.g., ART1, ART2, ART3, and Fuzzy ART). ARTMAP works as well as the K-means algorithm in most cases and better in some cases. The advantages of ART include (1) stabilized learning, (2) the ability to learn new things without forgetting what was already learned, and (3) the ability to allow the user to control the degree of match required. The disadvantages of ART include (1) the need for several iterations before learning becomes stabilized, (2) use adaptive weights, which are computationally expensive, and (3) the need for compliment coding for best performance, which means that the input data and stored weights take up generally twice as much memory space as otherwise. As in the case for K-means, the time complexity for ART is O(R K N) where K is the number of clusters or categories, R is the number of iterations, and N is the number of inputs.

Because of constraints on processing time and database space, a need exists for a clustering method and system that provides the advantages of the K-means and ART processes without their above-mentioned disadvantages.

### BRIEF SUMMARY OF THE INVENTION

The present invention is directed to a method and apparatus for clustering data inputs into groups. The first data input is initially designated as center of a first group. Each other data input is successively analyzed to identify a group center sufficiently close to that data input by determining if it is above a previously defined match threshold. If the proximity between the data input and no existing group center is above the match threshold, a new group is created and the data input is designated as the center of the new group. The analysis of data inputs is repeated until all data inputs have been assigned to groups in this manner. Optionally, thereafter, for each data input, the closest group center to that input is determined, and the data input is assigned to the group having that center.

These and other features of the present invention will become readily apparent from the following detailed description wherein embodiments of the invention are shown and described by way of illustration of the best mode of the invention. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

For a fuller understanding of the nature and objects of the present invention, reference should be made to the following detailed description taken in connection with the accompanying drawings wherein:

FIG. 1 is a flow chart illustrating the first pass of the clustering method in accordance with a preferred embodiment of the invention;

FIG. 2 is a flow chart illustrating the second pass of the clustering method in accordance with the preferred embodiment of the invention;

FIG. 3 is a schematic diagram illustrating the reassignment of a data input to another group in the second pass; and

FIG. 4 is a flow chart illustrating the first pass of the clustering method in accordance with an alternate embodiment of the invention utilizing feedback.

### DETAILED DESCRIPTION OF PREFERRED EMBODIMENTS

The present invention is directed to a highly efficient method for clustering data. The method includes the advantages of the K-means algorithm and ART without the disadvantages mentioned above. The method can classify any set of inputs with one pass through the set using a computationally inexpensive grouping mechanism. The method converges to its optimal solution after the second pass. The method achieves this peak performance without the use of compliment coding. Furthermore, it allows the user to control the degree of the match between a data entry and a group.

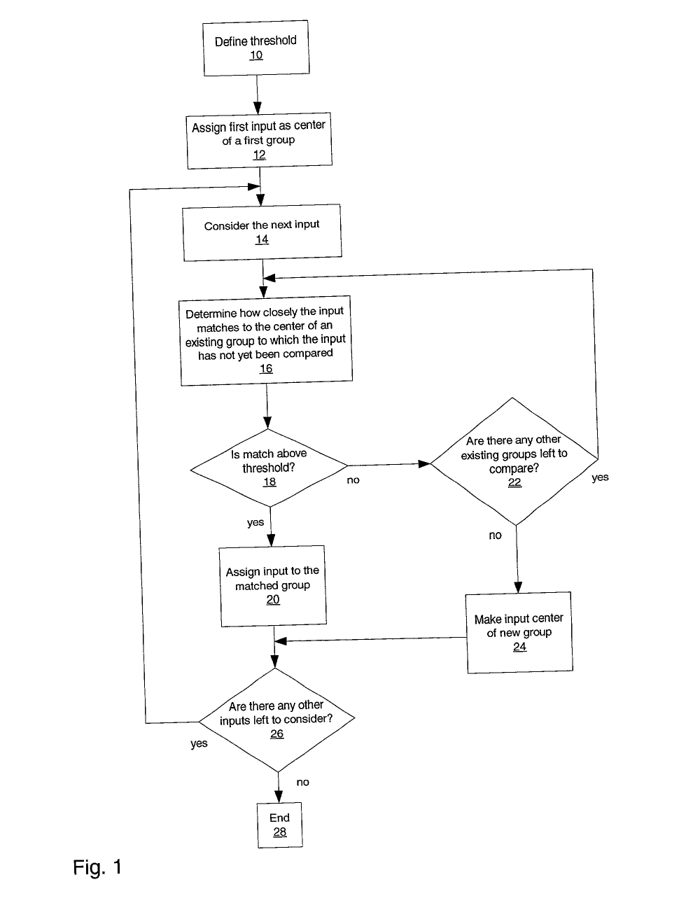

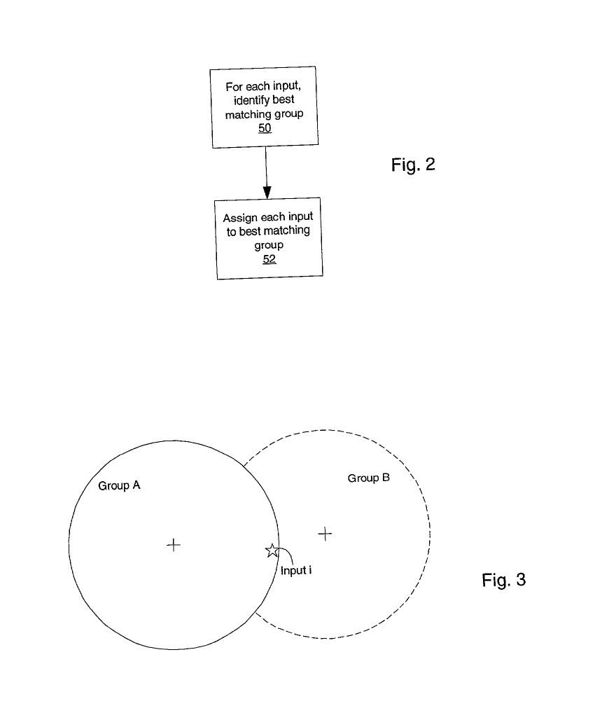

As will be described in greater detail below with respect to FIGS. 1 and 2, in general, the preferred method of clustering data uses groups, group centers, and a degree of match in a way that corresponds to topological concepts. Topological concepts are the concepts used to define a continuous function for any mathematical space. One of the fundamental concepts of Topology is the concept of open and closed sets. These open and closed sets are used in the definition of continuity. In two dimensions, the most common open sets used in describing Topological concepts are ‘neighborhoods’, which are two dimensional discs defined by a center x₀ and a radius r. The groups can be conceptualized as ‘neighborhoods’ that are circular in shape with a ‘center’ and a ‘radius’ determined by a threshold. The inputs (data entries) can be considered as vectors assigned to a given group if their distance from the center of the group is less than the radius of the neighborhood. The user controls the threshold, thereby controlling the size of the groups and indirectly controlling the number of groups. (A high threshold will lead to the creation of many small groups, while a low threshold will lead to the creation of a few very large groups.)

Briefly, in accordance with the preferred method, the first input is assigned to be the center of a first group. Then, each of the other inputs is successively compared to the center of an existing group until a sufficiently close match is found. This is determined by comparing how closely an input matches a group center to a predetermined threshold. When an input is determined to be sufficiently close to a group center, the input is assigned to be a member of that group. If there is no sufficiently close match to any group center, then the input is assigned to be the center of a newly created group. After all inputs have been assigned to a group, a second iteration is performed to place each input in the most closely matched group. Convergence is established after the second iteration. In many cases, the algorithm will achieve optimal or sufficiently optimal performance after only one iteration, however the algorithm's optimal performance cannot be guaranteed unless the second iteration is run. It is however never necessary to do more than two iterations since the algorithm converges after the second iteration.

These method steps are preferably implemented in a general purpose computer. A representative computer is a personal computer or workstation platform that is, e.g., Intel Pentium®, PowerPC® or RISC based, and includes an operating system such as Windows®, OS/2®, Unix or the like. As is well known, such machines include a display interface (a graphical user interface or “GUI”) and associated input devices (e.g., a keyboard or mouse).

The clustering method is preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

FIGS. 1 and 2 are flow charts illustrating the first and second iterations or passes, respectively, of a clustering method in accordance with a preferred embodiment of the invention. In FIG. 1, at step 10, the user defines a threshold (based on a radius defining the size of each group). At step 12, the center of a first group is defined by the first input. Each of the remaining inputs is then successively analyzed and assigned to a group at steps 14-28. At step 14, the next input is considered. At step 16, how closely the input matches a group center is determined for an input by calculating the distance between the input and the center of that group. At step 18, the distance is compared to the threshold. If the match is above the threshold (i.e., the distance between the input and the group center is sufficiently small), then at step 20, the input is assigned to be a member of that group. On the other hand, if at step 18, the match is determined not to be above the threshold, then a determination is made as to whether there are any other groups left to consider. If so, the process returns to step 16 to consider another group. If not, then at step 24, the input is defined as the center of a new group.

At step 26, a determination is made as to whether there are any other inputs to consider. If not, the process ends at step 28. If so, the process returns to step 14. All inputs are thereby successively assigned to a group.

As illustrated in FIG. 2, a second iteration can be performed to optimally match inputs to groups in accordance with a further preferred embodiment of the invention. As illustrated in FIG. 3, after the first iteration, some inputs might not be assigned to the best matching group. For example, as shown, input i is assigned to group A. However, it is closer to the center of group B, which was formed after the input was assigned to group A. The second iteration would reassign input i to group B.

As shown in FIG. 2, at step 50, each input (previously assigned to a group in the first iteration shown in FIG. 1) is analyzed to identify the closest matching group by calculating the distance between the input and each group center. Then, at step 52, each input is assigned to its closest matching group, which may or may not be the group it was assigned to in the first iteration.

An example of the preferred method is now described. For simplicity, the particular example described involves input vectors having binary values (i.e., values consisting of zeros and ones). It should be understood that the invention is equally applicable to analog inputs having varying values. (For analog values, a distance measure, e.g., like the Lp norm can be used. The Lp norm is ((x₀−x₁)^{p}+(y₀−y₁)^{P})^{1/P}. In two dimensions the Lp norm is the L2 norm, which is the standard Euclidean distance.

The example data consists of the following set of 6-dimensional input vectors: (1, 1, 1, 1, 1, 0), (1, 1, 1, 1, 0, 1), (0, 0, 0, 0, 0, 1), (1, 1, 0, 1, 0, 1). The first input (1, 1, 1, 1, 1, 0) is assigned to group A and the center of that group is defined as (1, 1, 1, 1, 1, 0). The second input is compared to all of the existing groups. Currently, there is only one group (group A) to which to compare it. The comparison is done in two ways, both of which (in this example) must exceed the threshold set by the user. The user has previously selected a threshold say, e.g., 0.7. The comparison involves determining in how many positions the input vector (1, 1, 1, 1, 0,1) and the center of group A (1, 1, 1, 1, 1, 0) both match with a value of 1. In this case, the first four positions match with values of group A. Accordingly, the number of matches is four. The number of matches is then divided by the total number of ones in the group center (4/5=0.8) and by the number of ones in the input vector (4/5=0.8). If both of these numbers exceed the threshold of 0.7 (as is the case), then there is a match and the input vector is added to group A. Group A now contains two members, (1, 1, 1, 1, 1, 0) and (1, 1, 1, 1, 0, 1), and has a center of (1, 1, 1, 1, 1, 0). The next input (0, 0, 0, 0, 0, 1) has no value 1 matches with the center of group A, so the degree of match is 0/5=0 and 0/1=0, both of which fail to pass the threshold. The input is accordingly made the center of a new group (group B). The final input (1, 1, 0, 1, 0, 1) does not sufficiently match the center of group A (degree of match =3/5 and 3/4) or group B (degree of match =1/1 and 1/4) and is accordingly made the center of a new group, group C. Each of the inputs is thereby assigned to a group in the first iteration.

A second iteration can then optionally be performed to optimize group matching. In this iteration, each input that has not been assigned as a group center is compared to the center of each group to determine how closely it matches the group center. In the example above, only input 2 is not assigned as a group center. It is compared to each of the group centers, and its degree of match with the centers of groups A, B, and C is (4/5, 4/5), (1/1,1/5), and (4/4, 4/5), respectively. As is apparent, input 2's match with group C is slightly better than group A. Accordingly, in the second iteration, input 2 is reassigned to group C.

The above described clustering process will converge after only two iterations, thereby providing a highly efficient data grouping. The process has a time complexity upper bound of O(2K N) and a lower bound of O(KN), with most applications fitting in the middle of this range around 0(1.5KN). Since most applications of ARTMAP and K-means require 3 iterations or more to converge and have a time complexity >O(3KN), this means the present algorithm will be at least twice as fast in most cases. Further since, one cannot predict ahead of time how many iterations it will take for ARTMAP and K-means to converge, users implementing those algorithms often run more iterations than necessary. It is not uncommon for users to use at least 5 iterations. The inventive process by contrast offers a computational time savings of anywhere from 100% to 300% or more.

Supervised Learning

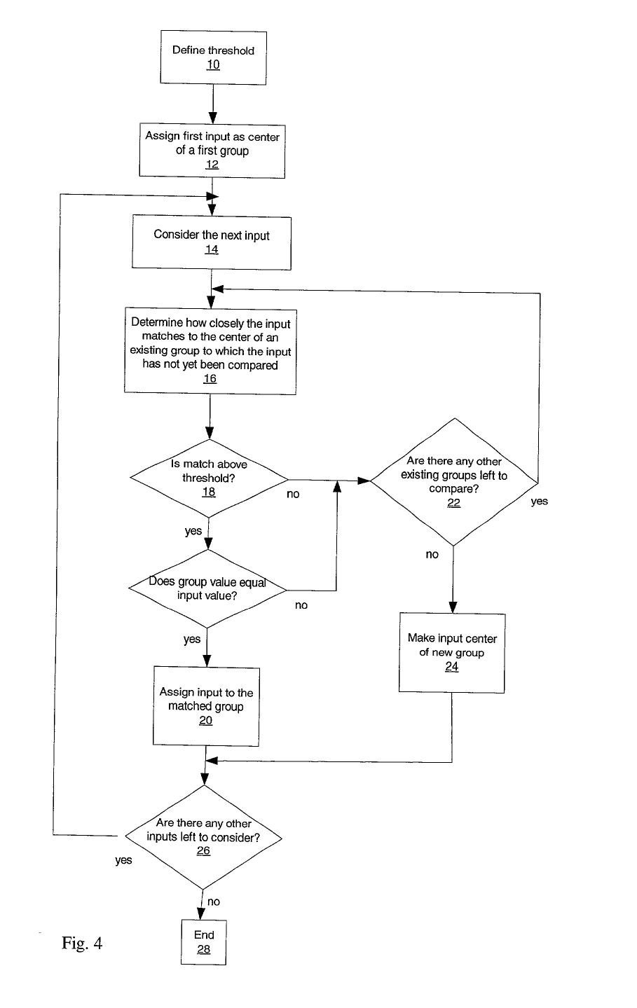

In accordance with a further embodiment of the invention, the above described process is extended to use supervised learning or feedback as illustrated in FIG. 4. As in any system involving supervised learning, the system is first trained on a training set. The training set comprises a set of input vectors with corresponding responses. For the supervised learning, the concept of a group is extended. In the clustering process described above, a group comprised a center and other data inputs that matched the center within a pre-selected criterion. For the supervised learning embodiment, a group comprises not only a center and other inputs, but also a value of the group. The value is preferably binary and generally corresponds to “True” and “False” or “Positive” and “Negative”. The supervised learning process is similar to the clustering process described above with the addition of a new match criterion. Now, not only must an input match the group center as described above, but also the value of the input must match the value of the group as illustrated by the additional step 19 shown in the flowchart of FIG. 4.

As an example, consider the following set of data inputs: (1, 1, 1, 1, 1, 0), (1, 1, 1, 1, 0, 0), (1, 1, 1, 0, 0, 0), (1, 1, 0, 0, 0, 0) with the corresponding values of 0, 1, 1, 0, respectively, and a threshold of 0.7. Consider the inputs in this example to be vectors representing six distinct characteristics of mushrooms (they could be color, smell, size, etc), where a ‘1’ indicates that the mushroom has the characteristic and a ‘0’ indicates that it doesn't have the characteristic. So for input (1,1,1,1,1,0), the mushroom has the first five characteristics and doesn't have the sixth. Further consider the corresponding values to represent whether or not the mushroom is edible, where a value of 1 indicates that the mushroom is edible and a value of 0 represents that the mushroom is poisonous. The first input (1, 1, 1, 1, 1, 0) becomes the center of group A, and group A is assigned a value of 0. The next input (1, 1, 1, 1, 0, 0) is compared to the center of group A (4/5 and 4/4) and is determined to be above threshold. However, because the value of the input is 1 and the value of group A is 0, there is no match and the input becomes the center of a new group, group B. This shows the value of supervised learning. With supervised learning the first mushroom, which is poisonous is not put in the same group as the second mushroom, which is edible. Without supervised learning, the two mushrooms would be put into the same group, leading to the possibility that someone could eat the poisonous mushroom because the algorithm indicated it belonged to the same groups as the edible mushroom. The next input (1, 1, 1, 0, 0, 0) does not match the center of group A (3/5 and 3/3), but does match the center of group B (3/4 and 3/3), and the value of the input also matches the value of group B. Therefore, the input becomes a member of group B. The final input (1, 1, 0, 0, 0, 0) doesn't match the center of either group and thus becomes the center of group C.

Applications

There are numerous possible applications for the clustering processes described above. These applications include, but are not limited to, the following examples:

The clustering process in accordance with the invention can be used in profiling Web users in order to more effectively deliver targeted advertising to them. U.S. patent application Ser. No. 09/558,755 filed on Apr. 21, 2000 and entitled “Method and System for Web User Profiling and Selective Content Delivery” is expressly incorporated by reference herein. That application describes grouping Web users according to demographic and psychographic categories. A clustering process in accordance with the invention can be used, e.g., to identify a group of users whose profiles (used as input vectors) are within a specified distance from a subject user. Averaged data of the identified group can then be used to complete the profile of the subject user if portions of the profile are incomplete.

Another possible application of the inventive clustering process is for use in a system for suggesting new Web sites that are likely to be of interest to a Web user. A profile of a Web user can be developed based on the user's Web surfing habits, i.e., determined from sites they have visited, e.g., as disclosed in the above-mentioned application Ser. No. 09/558,755. Web sites can be suggested to users based on the surfing habits of users with similar profiles. The sites suggested are sites that the user has not previously visited or has not visited recently.

The site suggestion service is preferably implemented in software and is accessible through the client tool bar in the browser of a Web client device operated by the user. The user can, e.g., click on a “New Sites” button on the tool bar and the Web browser opens up to a site that the user has not been to before or visited recently, but is likely to be interested in given his or her past surfing habits.

The Web site suggestion system can track and record all Web sites a user has visited over a certain period of time (say, e.g., 90 days). This information is preferably stored locally on the user's client device to maintain privacy. The system groups the user with other users having similar content affinities (i.e., with similar profiles) using the inventive clustering process. By grouping the users and assigning each user a unique group ID, the system can maintain lists of sites that a group members have visited without violating the privacy of any of the individual members of the group. The system will know what sites the group members have collectively visited, but is preferably unable to determine which sites individual members of the group have visited to protect their privacy.

A list of sites that the group has visited over the specified period of time (e.g., 90 days) is kept in a master database. The list is preferably screened to avoid suggesting inappropriate sites. The group list is preferably sent once a day to each user client device. Each client device will compare the group list to the user's stored list and will identify and store only the sites on the group list that the user has not visited in the last 90 days (or some other specified period). When the user clicks on the “New Sites” button on the client toolbar, the highest rated site on the list will preferably pop up in the browser window. The sites will be rated based on their likelihood of interest to the user. For example, the rating can be based on factors such as the newness of the site (based on how recently it was added to the group list) and popularity of the site with the group.

Another use of the inventive clustering process is in a personalized search engine that uses digital silhouettes (i.e., user profiles) to produce more relevant search results. As with the site suggestion system, users are grouped based on their digital silhouettes, and each user is assigned a unique group ID. For each group, the system maintains a list of all search terms group members have used in search engine queries and the sites members visited as a result of the search. If the user uses a search term previously used by the group, the system returns the sites associated with that term in order of their popularity within the group. If the search term was not previously used by anyone in the group, then the system preferably uses results from an established search engine, e.g., GOOGLE, and ranks the results based on how well the profiles of the sites match the profile of the user.

Having described preferred embodiments of the present invention, it should be apparent that modifications can be made without departing from the spirit and scope of the invention.

1. A method for clustering a plurality of data inputs into groups, comprising:
(a) defining a match threshold;
(b) designating a first data input as center of a group;
(c) analyzing another data input to identify a group whose center has a proximity to the input that is above the match threshold, and if such a group is identified, assigning the data input to that group;
(d) if the data input has a proximity to the center of no group above the match threshold, creating a new group and designating said data input as center of the new group; and
(e) repeating steps (c) and (d) until all data inputs have been assigned to groups.

2. The method of claim 1 further comprising (f) identifying the closest group center to each data input and, and assigning the data input to the group having that center.

3. The method of claim 1 wherein each data input comprises an input vector.

4. The method of claim 1 wherein said match threshold specifies a maximum distance between a data input and a group center.

5. The method of claim 1 wherein identifying a group center closest to an input comprises calculating the distance between each group center and the input and selecting the smallest distance.

6. The method of claim 5 wherein each data input is a binary vector input, and wherein calculating the distance comprises determining the degree of match by counting the number of matching positions in each vector.

7. The method of claim 5 wherein each data input is a non-binary vector input.

8. The method of claim 1 further comprising using feedback to more closely match data inputs to groups.

9. The method of claim 8 wherein using feedback comprises assigning an input to a group only if the input has a value matching a value of the group.

10. A computer program product in computer-readable media for clustering a plurality of data inputs into groups, the computer program product comprising:
means for designating a first data input as center of a group; and
means for successively analyzing each of the other data inputs to identify a group having a center whose proximity to the data input is above a predetermined match threshold, assigning said data input to the identified group; and if no group is identified, creating a new group and designating the data input as center of the new group; and repeating data input analysis until all data inputs have been assigned to groups.

11. The computer program product of claim 10 further comprising means for identifying the closest group center to each data input and, and assigning the data input to the group having that center.

12. The computer program product of claim 10 wherein each data input comprises an input vector.

13. The computer program product of claim 10 wherein said match threshold specifies a maximum distance between a data input and a group center.

14. The computer program product of claim 10 wherein the means for identifying a group center closest to an input calculates the distance between each group center and the input and selects the smallest distance.

15. The computer program product of claim 14 wherein each data input is a binary vector input, and wherein calculating the distance comprises determining the degree of match by counting the number of matching positions in each vector.

16. The computer program product of claim 10 wherein said computer program product further comprises means for using feedback to more closely match data inputs to groups.

17. A computer, comprising:
at least one processor;
memory associated with the at least one processor;
a display; and
a program supported in the memory for clustering a plurality of data inputs into groups, the program comprising:
means for designating a first data input as center of a group; and
means for successively analyzing each other data inputs to identify a group center closest to each data input, and if the proximity between the data input and the closest group center is above a predetermined match threshold, assigning said data input to the group having said group center; and if the proximity between the data input to the closest group center is not above the match threshold, creating a new group and designating the data input as center of the new group; and repeating data input analysis until all data inputs have been assigned to groups.
means for successively analyzing each of the other data inputs to identify a group having a center whose proximity to the data input is above a predetermined match threshold, assigning said data input to the identified group; and if no group is identified, creating a new group and designating the data input as center of the new group; and repeating data input analysis until all data inputs have been assigned to groups.

18. The computer of claim 17 wherein the program further comprises means for identifying the closest group center to each data input and, and assigning the data input to the group having that center.

19. The computer of claim 17 wherein each data input comprises an input vector.

20. The computer of claim 17 wherein said match threshold specifies a maximum distance between a data input and a group center.

21. The computer of claim 17 wherein the means for identifying a group center closest to an input calculates the distance between each group center and the input and selects the smallest distance.

22. The computer of claim 21 wherein each data input is a binary vector input, and wherein calculating the distance comprises determining the degree of match by counting the number of matching positions in each vector.

23. The computer of claim 21 wherein each data input is a non-binary vector input.

24. A method of suggesting a Web site to a Web user, comprising:
identifying a group of Web users having similar profiles;
recording Web sites visited by Web users in the group;
for a Web user in the group, determining which of the sites visited by other users in the group have not been visited by the user; and
suggesting to the user the sites not visited by said user.

25. The method of claim 24 wherein identifying a group of Web users having similar profiles comprises using a clustering process to group users.

26. The method of claim 25 wherein users are designated as data inputs, and the clustering process comprises
(a) defining a match threshold;
(b) designating a first data input as center of a group;
(c) analyzing another data input to identify a group center whose proximity to said another data input is above the match threshold, and assigning said another data input to the group having said group center;
(d) if no group center is identified, creating a new group and designating said another data input as center of the new group; and
(e) repeating steps (c) to (d) until all data inputs have been assigned to groups.

27. The method of claim 26 further comprising (f) identifying the closest group center to each data input and, and assigning the data input to the group having that center.

28. The method of claim 24 further comprising rating the sites not visited by the user based on how frequently other users in the group have visited the sites, and suggesting the highest rated sites to the user.

29. The method of claim 24 wherein suggesting to the user sites not visited by the user comprises providing a button on a client device operated by the user, said button linked to the sites not visited by the user.

30. The method of claim 29 wherein said button is on a browser tool bar on the client device.

31. The method of claim 24 wherein data on sites visited by each user is stored on a client device operated by said user.

32. The method of claim 31 wherein determining which of the sites visited by other users in the group have not been visited by the user is performed by the client device operated by the user.

33. A method of organizing search engine results, comprising:
identifying a group of Web users having similar profiles;
recording search queries made by the users in the group and Web sites visited by users resulting from said search queries; and
for a Web user in the group making a search query, determining if the query was previously made by other users in the group and, if so, identifying to the user the Web sites visited by other users resulting from said search query.

34. The method of claim 33 further comprising rating the Web sites identified to the user based on how frequently other users have visited the sites resulting from said query.

35. The method of claim 33 wherein identifying a group of Web users having similar profiles comprises using a clustering process to group users.

36. The method of claim 35 wherein users are designated as data inputs, and the clustering process comprises
(a) defining a match threshold;
(b) designating a first data input as center of a group;
(c) analyzing another data input to identify a group center whose proximity to said another data input is above the match threshold, and assigning said another data input to the group having said group center;
(e) if no group center is identified, creating a new group and designating said another data input as center of the new group; and
(f) repeating steps (c) to (e) until all data inputs have been assigned to groups.

37. The method of claim 36 further comprising (g) identifying the closest group center to each data input and, and assigning the data input to the group having that center.

38. A method for clustering a plurality of data inputs into groups, comprising:
(a) designating a first data input as center of a group;
(b) analyzing another data input to determine if it is sufficiently close to a center of a group and, if so, assigning the data input to the group;
(c) if no group is found to be sufficiently close to the data input, defining a new group and assigning the data input to the new group; and
(d) repeating steps (b) and (c) until all data inputs have been assigned to groups.
